(19) United States
(12) Patent Application Publication
(10) Pub. No.: US 2022/0369619 A1
(43) Pub. Date: Nov. 24, 2022

(54) DEVICE FOR DISPERSING ANIMALS WITH LASER LIGHT

(71) Applicant: Plancke - Van Gelderen - Braekeveld by, Ardooie (BE)

(72) Inventors: Guy PLANCKE, Ardooie (BE); Dirk VAN GELDEREN, Ardooie (BE)

(21) Appl. No.: 17/755,189

(22) PCT Filed: Oct. 23, 2020
(86) PCT No.: PCT/EP2020/079944

§ 371 Date: Apr. 22, 2022

(30) Foreign Application Priority Data
Oct. 25, 2019 (BE) BE2019/0093

(51) Int. Cl. A01M 29/10; F16M 11/14

(52) U.S. Cl. CPC A01M 29/10; F16M 11/14

(57) ABSTRACT

The invention relates to a device and a method for chasing animals such as birds utilizing laser beams, comprising a frame, a laser light source connected to the frame, including a laser light source for generating a laser light beam, a power supply circuit for feeding the laser light source, drive means for moving at least a part of the laser light source and a controller for controlling the laser light source and the drive means of the laser light source, wherein the purpose is to provide one or more moving laser dots on a surface.

### FIELD OF THE INVENTION

The present invention relates to the repelling of animals such as birds. In particular, birds can cause nuisance, by leaving their excrement on terraces, playgrounds, stadium benches, etc.

### BACKGROUND

According to the state of the art, a device for repelling birds is known which is provided with a frame, a connection to the frame laser light source including a laser light source for generating a laser light beam, a power supply circuit for the feeding of the laser light source, drive means connected to the laser light source for causing movement of at least a part of the laser light source and a control means for controlling the laser light source and the drivable part of the laser light source.

When activated, this known device generates a laser beam, which is intended to scare away the birds. If the device fixed, the laser beam is stationary and the repellent effect is limited, in particular since the birds become get used to the presence of the laser beam.

The objective of the present invention is to provide a device of which the repellent effect is greater.

This goal is achieved in a way that the drive means are able to move the frame, in which the laser light source is housed.

This setup produces a moving laser beam, which has a much greater deterrent and scaring effect than a stationary beam. It is noted that the birds see the laser beam as a physical object and are therefore chased away more quickly. However, as opposed to the prior art devices, which generates laser beams to present the illusion of a solid surface (the beams defining the contours thereof by its speed), the present invention uses the dots that are generated on a surface on which the beam impinges.

The invention concerns also a method to chase away birds, comprising a generating bird repellent laser beam in a frame, wherein the laser beam carries out a movement.

### SUMMARY OF THE INVENTION

According to a first embodiment, the frame which is arranged flexibly on a support or mounting means, for instance by making use of one or more springs, and is provided with a laser light source, wherein the frame is movable by natural forces such as wind, and wherein the generated laser light rays perform a (random) movement. This embodiment has the advantage of very simple construction.

According to an embodiment, the frame is arranged flexibly on a support or mounting means, for example by making use of one or more springs, and is provided with the laser light source, wherein the frame is set in motion by mechanical forces such as an electric motor that causes a certain vibration and wherein the laser light perform a controlled movement. This movement can be made by the motor operating continuously or pulsating, causing the frame to vibrate and then expanding. This embodiment has the advantage of simple construction.

According to an embodiment, the frame is arranged flexibly on a support or mounting means, for example by using one or more springs, and is provided with a laser light source whereby the frame is movable by natural forces such as wind in combination with a system that makes use of mechanical forces such as an electric motor that causes a certain vibration and in which the laser light beams perform a controlled movement. The two drive systems (natural force and mechanical force) can complement each other. If the frame is not set in motion by the winding drive due to a lack of wind, if desired, the mechanical drive can take over.

According to an embodiment, the frame is fixedly mountable on a supporting surface (such as a wall, ground, roof, etc.) via a mounting means, and is provided with a laser light source, wherein the laser lights are set in motion by an electromechanical drive and wherein the laser light beams perform a structured or random movement.

The movement of the laser lights can be caused by moving the following things
The laser light source itself
a laser deflector
a mirror
or a combination of one or more previous parts

According to an embodiment, the frame is fixed, provided with the laser light source, wherein the laser lights are set in motion by natural forces such as wind and wherein the laser light beams perform a random movement.

The movement of the laser lights can be caused by moving the following things
the laser light source itself
a laser deflector
a mirror
or a combination of one or more previous parts.

According to an embodiment, the frame is fixed, provided with the laser light source, whereby the laser lights are set in motion by natural forces such as wind in combination with electromechanical drive, whereby the laser light rays can perform a random or structured movement.

The movement of the laser lights can be caused by moving the following things
The laser light source itself
a laser deflector
a mirror
or a combination of one or more previous parts

It is in principle possible for the laser light source to allow movement, in the particular, when the laser light source has a simple construction. However, when a larger area has to be covered, it is preferred that multiple light points are used to cover this area.

According to a first embodiment, a laser dot formed by the laser light source is moving back and forward to cover a certain area. The arrangement is equipped with vibration means in a way the path of the laser light generated by the laser light source, and the laser light dot, is not linear. Giving the path a non-linear path avoids habituation of laser dots by the birds. If the laser dot always follows the same path in a same way the birds can get used to this phenomenon and no longer be deterred.

According to an embodiment, the laser light beam(s) generated by the laser light source is split into several light points. This can be accomplished by using a so-called beam splitter. A single laser light beam is split into several beams. By using, for example, a prism, the laser beam can be split into two or more separate beams that possibly have the same diameter of the beam, but whose strength is disproportional to the number of split beams.

By using multiple laser light points working in close proximity of each other, the advantage is that the laser lights themselves can and may move much slower, which means a higher efficiency on the one hand and this is also less disturbing for those who can see the dots/light on the other hand.

Also, it can be understood that a slower movement is less stressful for the mechanical parts, especially when the drive is done via a natural force such as the wind.

If the laser light beams come from the same laser, whereby the laser beam is divided into separate light beams, it is logical that the light points on the surface move simultaneously. However, if several laser light sources are used, one or more laser light points may move separately from each other, randomly or even in a structured manner through each other.

Since the deterring effect on animals such as birds gives a certain period before they try to return, it's not necessary to keep the laser lights running constantly. It can work also in pulses with time intervals of e.g. 10 s, 20 s, 30 s, 1, 2 or 5 minutes, especially in case several laser light sources are used.

When using multiple lasers, the light beams generated by the different laser sources can be tuned to each other so that they can operate in concert with each other. In an alternative embodiment, these can also work independently of each other, so that they can efficiently operate alternatingly to limit power consumption.

According to a particular embodiment, the frame is connected flexibly via a connection element to a mounting means or support to be affixed to an external support structure (wall, roof, etc.), where a possible embodiment here is that the frame is connected to the mounting means according to the following possibilities:
spring mechanism in which the frame rests or hangs on at least one spring;
the frame is attached to the mounting means utilizing a rotating rod joint using a material such as rubber to limit movement but still keep it flexible.

According to a particular embodiment, the frame can also be driven electromechanically, this can be done in the following ways:
the drive mechanism is located in the frame itself and causes the frame to move through a certain movement;
the drive mechanism is located in the flexible connection element itself and causes the frame to move through a certain movement;
the drive mechanism is located on the frame and, via a certain movement, sets the flexible connection element in motion and therefore also indirectly to the frame;
or a combination of one or more previous systems.

The purpose of the flexible connection element is to make the frame, and therefore indirectly also the laser light, move.

These movements can include:
just back and forth;
just up and down;
a combination of up and down and back and forth;
all possible directions.

If a detector senses that there is no movement due to the wind for a certain amount of time, the mechanical drive can be programmed to take over.

Since it is preferable to use green laser light with a light frequency between 500 and 600 nm and even between 520 and 530 nm, the system is preferably switched off as soon as people are in the vicinity.

To achieve this, use is made of sensors such as motion sensors, which use infrared techniques and are commonly used in many technical fields.

These sensors can be placed on
The frame
a fixed or flexible connection element
a mounting means
or a combination of one or more previous places

An alternative system is that detection is used to recognize animals such as birds and activate the system only when it is needed. This could be in combination with a human sensor that prevents the lasers from being activated or switched off again if people come close.

Although a single laser beam can scare the birds by defining a seemingly solid surface, it only creates a small area where the birds are driven away from by the laser beam as it needs to move slow enough to create the illusion of a seemingly solid surface. Therefore, there is a need for a method and device that covers a larger area, so that the deterring effect extends over a larger area.

This objective is achieved using a control means in such a way that the intended surface is covered by one or several laser points that are sufficient to keep the birds away from the intended surface. Less important is that the laser points move dependently or independently of each other. The different laser beams must be controlled in such a way that animals such as birds are chased away efficiently. If a natural drive such as wind force is used, the lasers can be controlled to pursue a periodic pattern of movement and/or of functionality. This in a way in which the time intervals between passage of the laser beam at or around a position or zone are not too long, so that the animals do not have the time to adjust and land on the intended surface, according to plan, but also not too short so that an unnecessary amount of power is consumed.

Directing the laser beam to the ground creates a spot of light, which, especially when moving towards the birds, scares the birds away. The laser beam itself, when it has sufficient power, is also visible to birds.

To increase the deterring effect of the laser beam, it is preferred that the device is adapted to make the laser beam move continuously. The preferred trajectory is the laser dot moving relative slowly in one direction and jumping back to its starting position after it has reached its end point. This is to avoid that it takes too long before the laser dot returns back to his start position.

After the birds have been chased away by the device according to the invention, they often return to the position from which they have been chased, in particular when these positions are attractive to the birds, for instance, due to the presence of edible plants. To chase the birds away again after the birds have returned, a preferred embodiment proposes that the control member is arranged to cause the laser beams to repeatedly execute a program. It is possible for the program at regular intervals is performed, but also the frequency is irregular.

Because of the simple design, it is advantageous if the control member is arranged to execute the same program each time if the drive is electromechanical.

However, it is also possible that the control element is arranged to each time execute a different program. The controller must or be configured to control various programs.

In particular, when the device operates autonomously, that is to say without detection or prediction of birds, it is attractive when the control member is arranged for executing a program at predetermined times. Said points of time may at varying intervals of, such as, for example, determined by a random number source, are determined, but it is also possible in that at fixed points in time or the program is executed at fixed intervals. It is also possible to include the influence of light in determining the times at which the program is executed and the choice of the program.

In order to avoid unnecessary energy consumption and to prevent the birds getting used to a pattern, according to a possible preferred embodiment, the device is provided with a bird detection device for detecting birds in the vicinity of the device The bird detection device is connected to the control device and the device is control element arranged for executing a program after detection of a number of birds by the bird detection element. With these measures, the program is only executed when birds are actually present.

The invention also relates to a method in which the laser beams carry out a program after the detection of some birds.

### DESCRIPTION OF FIGURES

FIG. 1: General perspective view of the device, with the frame being arranged flexibly concerning the structure.

FIG. 2: View in perspective of the frame, wherein the frame is arranged flexibly relative to the structure.

FIG. 3: General and opposite view to FIG. 1 in the perspective of the device with the frame being arranged flexibly relative to the structure.

FIG. 4: Opposite view to FIG. 2 in the perspective of the frame, with the frame being arranged flexibly relative to the structure.

FIG. 5: General perspective view of the device, with the frame being fixedly arranged relative to the structure.

FIG. 6: View in perspective of the frame, wherein the frame is fixed relative to the structure.

FIG. 7: Internal view of components of device.

FIG. 8: Internal view of components of device.
1. Frame: one or more the following elements may be included herein
   Laser light source
   Driver
   Mirror
   Deflector
2. Mounting means/support: This is the structure on which the frame is mounted in a flexible or non-flexible manner.
3. Laser beam: This is the light processed by the laser light source.
4. Laser light source: This generates the laser light beam.
5. Frame movement means: This can make the flexible connection element (spring) between frame and mounting means move and therefore also the frame.
6. Frame movement means: This version of the frame movement means can make the frame move on its own.
7. Wind catcher: This is attached to the frame to allow the frame to move through a natural force.
8. Surface: The surface that is desired to be kept bird-free.
9. Sensor: This can be a sensor for detecting people as well as for detecting animals such as birds.
10. Deflector and splitter: Depending on the setup, this can only deflect the laser, but also divide it into different laser light beams, possibly utilizing a device such as a prism.
11. Window: This is the opening in the frame through which the laser light can shine trough. Depending on the version, it may or may not be provided with a translucent surface.
12. Spring: In the case of a flexible arrangement, the spring is used as a flexible arrangement.
13. Fixed connection: In the case of a fixed installation, a rigid connection is used.
14. Rod: This is set up in the spring to limit the movement of the spring itself.
15. Mirror: This provides the reflection and direction of the laser lights.
16. Frame: the following elements may be included
   Laser light source
   Driver
   Mirror
   Deflector
In this set-up the casing can act as a wind-catcher
17. Mounting means: This is the structure on which the frame is mounted in a flexible manner.
18. Laser beam: This is the light processed by the laser light source. The laser beam moves back and forward by the mirror means.
19. Laser light source: This generates the laser light inside the frame.
20. Reflective surface/Deflector/mirror: This provides the reflection and moving direction of the laser lights.
21. Reflective surface movement means: On this spring the mirror is mounted.
22. Reflective surface holder: This is a means that is connected with the mirror/reflective surface and can be manipulated in a way that the trajectory of the laser light beam can be adjusted in length.
23. Reflective surface movement means: This can make the spring move and therefore also the frame. This pushes the reflective surface holder.
24. Reflective surface movement means—motor: This moves the reflective surface movement means.
25. Casing-spring: The spring is used as a flexible connection element for the frame to the mounting means. If the frame is not moved by natural force such as wind the frame can be moved by the frame movement means, driven by a motor.
26. Frame movement means: This installation can make the frame move.
27. Rod: This is set up in the spring to limit the movement of the spring itself and transfer the movement from the frame to the mounting means.
28. Window/opening: This is the opening in the frame through which the laser light can shine trough. Depending on the version, it may or may not be provided with a translucent surface.
29. Sensor: This can be a sensor for detecting people as well as for detecting animals such as birds.
30. Fixing means: The part of the mounting means that holds the flexible connection element.
31. Frame movement means—motor: This actuates the frame movement means.
32. Settings-means: The movement of the frame has to be limited in relation to the distance between the device and the surface. Therefore the movement of the rod can be adjusted.
33. Fan: This cools the laser light source. In some embodiments the fan can have a weight eccentric attached to one or more vanes to give the frame a vibration.
34. Vibration weight: To generate a vibration to the frame.
35. Fixation ball: Fixation member of the connection element to position the frame in view of the mounting means, preferably fixable in a number of positions.
36. PCB (printed circuit board): This is to control the laser beam, sensors and motor devices.
37. Springs: To support the laser light source and stimulate the random movement of the frame.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a preferred embodiment, the invention pertains to a device for deterring animals, comprising a frame and a mounting means adapted for mounting the device onto a structure, said mounting means being flexibly connected to the frame via a flexible connection element adapted to allow relative movement of the frame with respect to the mounting means. The frame comprises at least one laser light source for generating at least one light beam; a power supply and associated circuit for powering the laser light source. The device further comprises frame movement means arranged to generate movement of the frame with respect to the mounting means, whereby said movement is preferably randomized.

The mounting means is adapted to be affixed to a supporting structure, such as a roof, wall, window pane, gate, or other structures. The way of affixation can vary strongly, and is in no way limitative to the invention at hand. The frame typically consists of a partly hollow body in which some of the more critical and fragile components and electronics, such as the laser light source, are situated, with an opening or window for the laser light beam to exit from. The frame and mounting means are flexibly connected to allow relative movement between the two when a force is exerted on either or both. This force can be deliberate (under influence of a motor or actuator of any kind on or around the device) or from the environment and thus more randomized (wind and the like). This relative movement is generated by the frame movement means, which can take the form of any one or more of the abovementioned actuators, motors, vibrating elements, but also of a wind catcher, a solar sail, or others.

In a preferred embodiment, the device comprises a laser movement means arranged to allow relative movement of the laser light source with respect to the frame. The laser movement means may be a simple flexible connection between the laser and the frame, thereby creating relative movement between the two upon movement of one, such as a spring-based connection as in the Figures. This has the advantage that, upon movement of the frame, an additional component of movement is added by the laser movement means to the path of the generated light beam, creating a more varied pattern of movement.

In a preferred embodiment, the device comprises a reflective surface suitable for deflecting the light beam of the laser light, away from the frame, whereby the laser light source is configured to irradiate said reflective surface. This reflective surface has been described previously. Preferably, the reflective surface is flexibly mounted on the frame via reflective surface movement means, allowing relative movement between the reflective surface and the laser light source, thereby varying the direction of the deflected light beam. Again, this may be via a flexible connection between reflective surface and the frame (springs or others), but variants can be envisioned. The reflective surface movement means preferably are adapted to allow a periodically repeating movement, and are most preferably mechanically or electronically based to ensure movement.

The movement means (laser, frame and/or reflective surface) may be passive and/or active. Passive embodiments can be springs and flexible connections, which create movement based on external forces or triggers. Active embodiments can encompass motors, vibrating elements and such, which create intrinsic movement. The device may comprise one or more power supplies for powering the movement means if necessary, and may also use these one or more power supplies to power the laser light source.

Preferably, the frame movement means is passive, the laser movement means is passive, the reflective surface movement means is active. This setup is a very simple way of ensuring that the only deliberate movement is performed by the reflective surface, as this is usually quite robust, whereas the laser source is more fragile. Preferably, the frame movement means is active, the laser movement means is passive, the reflective surface movement means is active. Again, the idea applies here that movement of the more fragile laser light source is done via passive means, to reduce the amount of movement, which can be accomplished easier by moving the other means.

Preferably, the frame movement means is active, the laser movement means is passive, the reflective surface movement means is passive. The same argumentation as above applies.

Preferably, the frame movement means is passive, the laser movement means is active, the reflective surface movement means is active. In this case, the laser light source and reflective surface are moved deliberately, allowing the frame to be relatively securely mounted, while movement is only performed inside of the frame, thus allowing a great variety in the movement of the laser light beams that are expelled from the device.

Preferably, the frame movement means is passive, the laser movement means is active, the reflective surface movement means is passive.

Preferably, the frame movement means is active, the laser movement means is active, the reflective surface movement means is passive.

In some embodiments, all movement means are passive. In others, all movement means are active.

In a preferred embodiment, the device comprises one or more vibrational movement means, configured to, preferably in a randomized pattern, add an additional movement component to the light beam generated by the laser light source, said additional movement component varying at least in the plane perpendicular to the direction of the light beam, whereby said one or more vibration movement means may influence the relative movement between the frame and the mounting means and/or the relative movement between the laser light source and the frame and/or the relative movement between the reflective surface and the frame. Such a vibration movement means is ideal in combination with flexible connections (e.g. springs) between frame and mounting means/frame and laser light source/frame and reflective surface, to add variation to the movement of the laser light beam.

In a preferred embodiment, the device comprises a rangefinder for measuring the free path length of the light beam, and whereby the movement speed of the laser light source and/or the deflection surface is adjusted based on the free path length.

By doing so, it can be ensured that the speed of movement of the laser dot generated by the laser light source remains in a desired range. Too fast or too slow will significantly lower its accuracy. By adding a rangefinder, the speed can be adjusted on each moment via a feedback loop.

In a specifically preferred embodiment, the laser light beam follows a predefined trajectory (or approximately, with some small variations), wherein part of the loop is run through in a first range of speed, and the rest of the loop in a second range of speed, wherein the second range of speed is at least 10, preferably at least 50, times higher than the first range of speed. This creates a suddenly very abrupt movement pattern that can scare birds efficiently, as well as return to a starting position very quickly to restart the tour, thereby ensuring each position is passed in a similar time frame (as opposed to a back-and-forth loop). This can for instance be provided by using an eccentric drive means as reflective surface movement means, wherein the eccentric's radius increases slowly over most part of the perimeter, and then reverts back to its lowest value very abruptly.

In a particularly preferred embodiment, the relative movement of the reflective surface is effected via a an eccentric mechanism cyclically tilting the reflective surface, preferably said eccentric mechanism having a perimeter which over at least 90% of the perimeter monotonously increases in radius from a minimal value, preferably at least 95% (more preferably even more, for instance 99%), wherein the radius is abruptly returned to its minimal value in the remaining part of the perimeter. The eccentric mechanism moves the reflective surface between two angular positions periodically, which creates a range of angles wherein the laser light beam is reflected.

In a preferred embodiment, the device comprises a control means which controls the laser light source, and one or more of the (active) movement means. This way, the movement of the laser light beam can be guided to followed predetermined patterns (with some variations optionally) that can be programmed into the control means.

In a preferred embodiment, the relative movement of the frame and/or of the reflective surface and/or of the laser light source is linear. Preferably, the relative movement of the reflective surface is linear. The movements of the others can preferably be more varied.

In a preferred embodiment, the frame comprises an opening or window, through which the light beam is directed, dimensioned to allow at least an angular variation of the light beam of 50°, preferably at least 60°, along at least one dimension of the opening or window, and more preferably at least 20°, or even 30°, 40° or more, in all dimensions of the opening or window.

In a preferred embodiment, the reflective surface and the laser light source are positioned such that the laser light source emits a laser beam generally parallel to the window or opening of the frame, with the reflective surface being positioned in an average angle of about 45° in view of the window or opening. As such, when the light beam is deflected by the reflective surface, it exits the window, and thus the frame, essentially perpendicularly thereto. By then varying the angle of the laser light source and/or the reflective surface, a variation can be achieved in view of said perpendicular emissions direction in order to arrive at the desired movement pattern of the laser light beam, and its resulting laser light dot on a surface that is to be guarded against animals, and in particular pigeons.

In a preferred embodiment, the movement means that dictate the general trajectory of the laser light beam, are suitable for allowing an adjustable speed of movement, in order to allow a user to set up a speed of movement for the laser light dot at a desired speed. This is preferably in the range of 50 cm/s up to 5 m/s, and more preferably between 1.0 m/s and 2.0 m/s. The main application of the invention is to situate the device at a distance between 1.0 m up to 10.0 m of the surface to be guarded. Taking into account a supposed linear trajectory wherein the angle of the beam from the device has a variation of 60° (meaning the total length of the linear path for the dot is also about 1.0 m up to 10.0 m), the movement means is adapted to perform cyclical movements with a period of at most 20 seconds, and at least 0.2 seconds, but preferably with a period of at most 10 seconds and at least 0.5 seconds, and more preferably at most 5.0 seconds and at least 1.0 seconds. Typically this is only one of the frame movement means, the laser light movement means or the reflective surface movement means, and preferably the reflective surface movement means as in the figures, as the latter is the easiest to manipulate.

It can be understood that in case of a smaller or larger total path lengths that the laser dot will travel, the frequency of the movement means can be adjusted to an appropriate frequency, be it lower or higher than what was discussed above.

The invention is further described by the following non-limiting examples which further illustrate the invention, and are not intended to, nor should they be interpreted to, limit the scope of the invention.

The present invention will be now described in more details, referring to examples that are not limitative.

### EXAMPLES AND/OR DESCRIPTION OF FIGURES

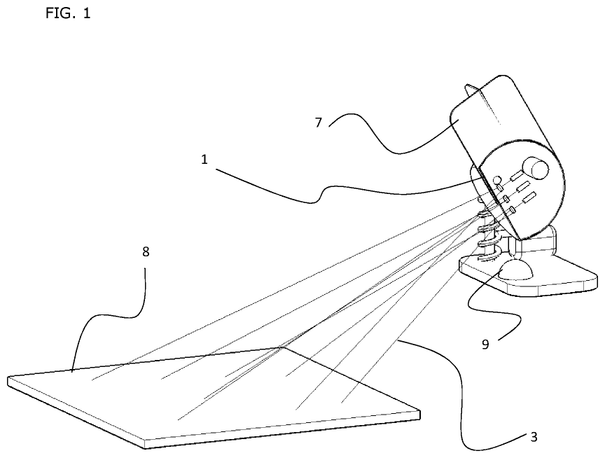

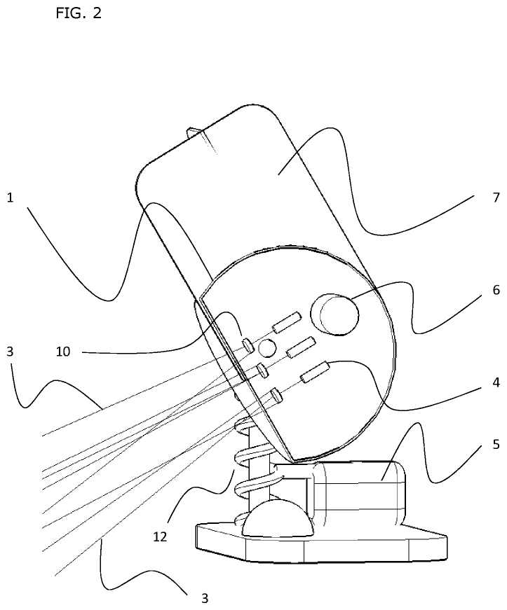

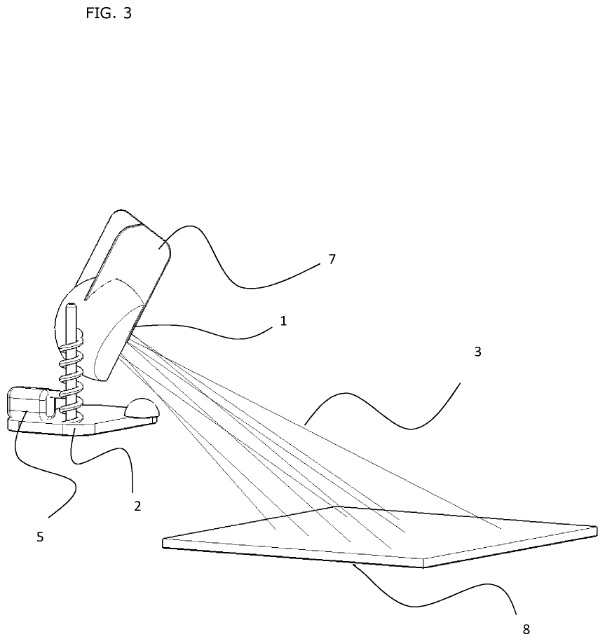

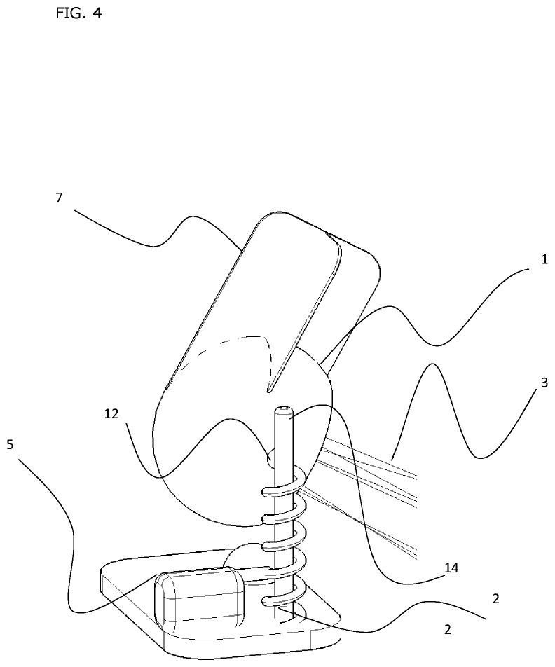

The system shown in FIGS. 1, 2, 3, and 4 is a device in which the frame 1 is flexibly arranged on a mounting means 2. The flexible connection element in this embodiment is composed of a spring 12 that allows the frame 1 to be moved in all directions. To restrict the movement of the frame 1, a rod 14 is provided in the spring 12. In frame 1 itself, there are several laser light sources 4 arranged in parallel next to each other in this embodiment. The laser light generated by these laser light sources 4 is divided using a prism 10 into several laser beams 3 which shine out through a window 11 intending to regenerate 8 different moving laser dots on a given surface. A wind catcher 7 is provided on the outside of the frame, which allows the frame 1 to be set in motion utilizing wind energy. Since there is a certain distance between the source of the laser lights 3 and the intended surface 8, even a small movement of the frame will cause a relatively large movement of the laser point on the surface 8. The frame 1 can be supplemented with an electromechanical drive 6 which can make the frame move by, for example, causing a vibration at times when there is too little wind for the frame 1 to move. This detector can be located in the frame 1 or elsewhere. In another embodiment, the electromechanical drive 6 is not located in the frame but is mounted on the mounting means 2 which is to be mounted against the spring 12, whereby the frame movement means (in this case, an electromechanical drive) 5 pushes against the spring to move the frame 1 indirectly.

The system can be supplemented with a sensor 9 to detect persons or animals such as birds or a combination of both. This sensor 9 can be mounted on the mounting means 2, but also on the frame 1 itself or at any other suitable location.

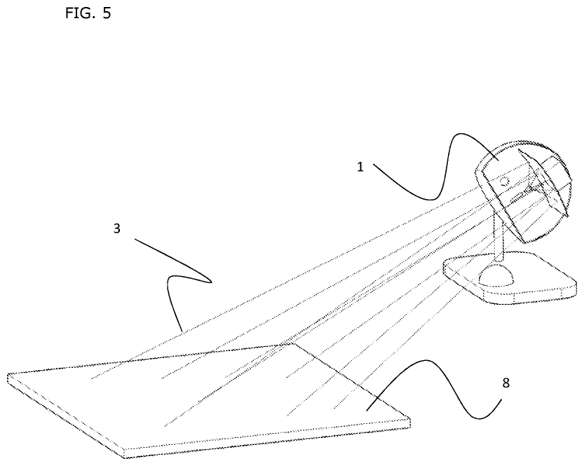

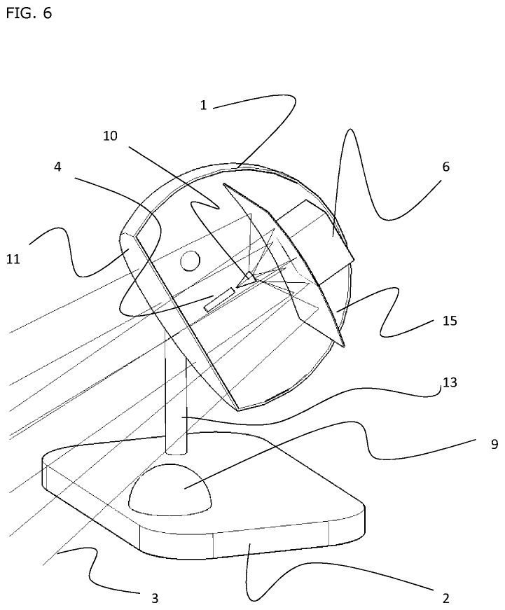

The system shown in FIGS. 5 and 6 is a device in which the frame 1 is fixedly arranged on a mounting means 2. The fixed device in this embodiment is composed of a rod 14 which fixes the frame 1 relative to the mounting means 2. In this embodiment, in the frame 1 there is one laser light source 4 in the frame 1 which divides the laser light generated via a prism 10 into several laser beams 3 which shine out through a mirror 15 and then a window 11 to regenerate different moving laser dots on a certain surface 8.

In this embodiment, the frame 1 is supplemented with a frame movement means 6 which can make the mirror 15 vibrate, so that the laser lights 3 are given a certain movement.

Since there is a certain distance between the source of the laser lights 3 and the intended surface 8, even a small movement of the frame will cause a relatively large movement of the laser point on the surface 8.

The system can be supplemented with a sensor 9 to detect persons or animals such as birds or a combination of both. This sensor 9 can be mounted on the mounting means 2, but also on the frame 1 itself or at any other suitable location.

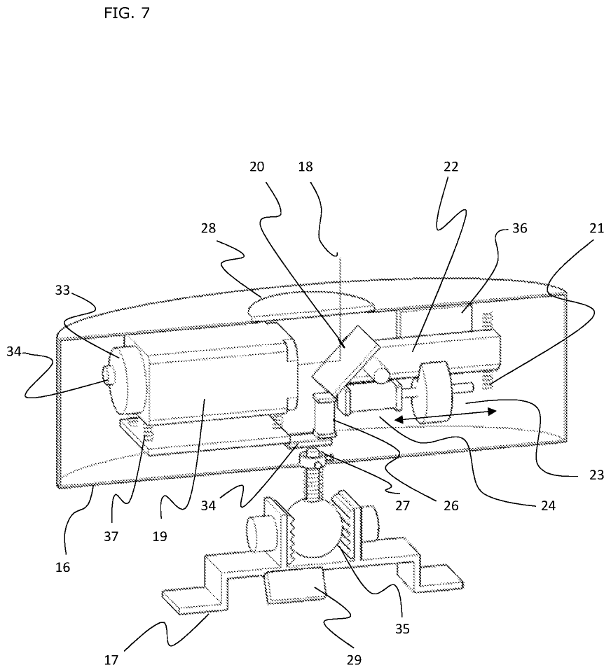

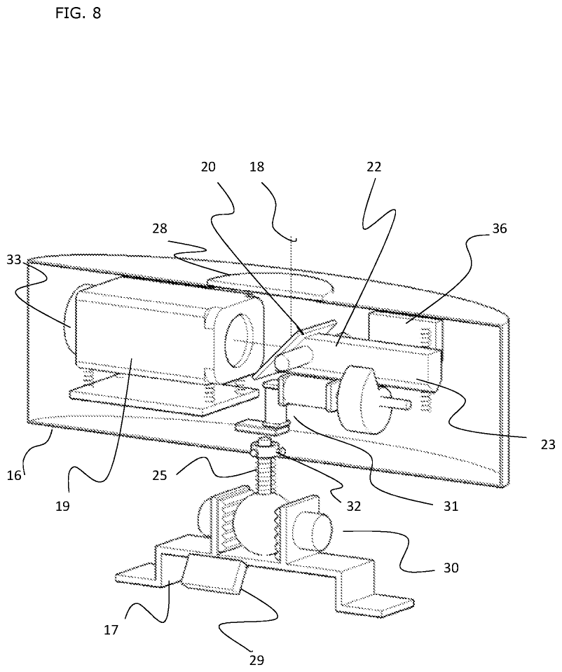

The system shown in FIGS. 7 and 8 is a device in which the frame 16 is flexibly arranged on a mounting means 17. The flexible connection element in this embodiment is composed of a case spring 25 that allows the frame 16 to be moved in all directions. To restrict the movement of the frame 16, a rod 27 is provided in the casing spring 25. This rod 27 is connected with the ball 35 which is the center of the fixing means 30. The casing spring 25 is fixed on the ball 35 on the one side and fixed to the frame 16 on the other side. The movement of the rod 27 is limited by a setting means 32. In the frame 16, there is at least one laser light source. The laser light source is preferably 19 arranged on springs 37 mounted on the frame 16. The laser beam 18 generated by these laser light source 19 shines on a mirror 20 that acts as a deflector. This mirror 20 is mounted on a reflective surface holder 22 around an axis that can rotate. The reflective surface holder 22 can be pushed away by the reflective surface movement means 23. This moves the dot of the laser beam 18 from its starting point to its end point. Once the dot of the laser beam 18 has reached the end point, the laser dot moves back to its starting point very quickly. The reason of this feature is that if the laser dot moves slowly, it takes too long before the laser dot moves back to its starting position.

By moving the reflective surface movement means 23 over the length of the reflective surface holder 22, the length of the path of the laser dot can be adjusted between his minimum and maximum. The motor 24 of the reflective surface movement means drives the reflective surface movement means 23. Because the combination of the mirror 20, reflective surface holder 22 and reflective surface movement means 23 can be kept very small, the motor 24 can be a very small and low power model.

The frame 16 can be used as a wind catcher which allows the frame 16 to be set in motion utilizing wind energy.

Another way to give the frame his random movement is to provide a separate frame movement means motor 31 using a frame movement means 26. This frame movement means 26 can be a weight 34 that is eccentric mounted on the axe of the motor 31. If the motor 31 rotates this causes a vibration. Because the motor is mounted on the frame 16, the frame 16 will vibrate and therefore the laser beam 18 will vibrate randomly.

Some laser sources, especially high powered laser sources, need to be cooled and can therefore be equipped with a fan 3. In this case a weight 34 can be added on one or more vanes of the fan 33. If the weight 34 is mounted eccentric this causes also vibration and the frame 16 can be moved in this way.

The laser beam 18 shines through a window 28 that can be flat but also curved, curved to simulate the shape of an eye. The frame 16 is mounted on the casing spring 25, this casing spring 25 is mounted on the fixation ball 35. In this embodiment, the fixation ball 35 is fixed by the fixing means 30. In this embodiment the fixation ball 35 is jammed by the fixing means 30. This arrangement allows to the frame 16 to positioned in different angles.

Since there is a certain distance between the source of the laser beam 18 and the intended surface, even a small movement of the frame will cause a relatively large movement of the laser point on the surface. The frame 16 can be supplemented with a sensor which makes the frame 16 move when there is too little wind for the frame 16 to move. This sensor or detector can be located in the frame 16 or elsewhere.

The system can be supplemented with a sensor 29 to detect persons or animals such as birds or a combination of both. This sensor 29 can be mounted on the mounting means 17, but also on the frame 16 itself or at any other suitable location.

It is clear that the method according to the invention, and its applications, are not limited to the presented examples.

The present invention is in no way limited to the embodiments described in the examples and/or shown in the figures. On the contrary, methods according to the present invention may be realized in many different ways without departing from the scope of the invention.

1. Device for deterring animals, comprising:
a. a frame;
b. a mounting means adapted for mounting the device onto a structure, said mounting means being flexibly connected to the frame via a flexible connection element adapted to allow relative movement of the frame with respect to the mounting means;
the frame comprising:
a. at least one laser light source for generating at least one light beam;
b. a power supply and associated circuit for powering the laser light source;
the device further comprising frame movement means arranged to generate movement of the frame with respect to the mounting means, whereby said movement is preferably randomized.

2. The device for deterring animals according to claim 1, wherein the device comprises one or more vibrational movement means, configured to, preferably in a randomized pattern, add an additional movement component to the light beam generated by the laser light source, said additional movement component varying at least in the plane perpendicular to the direction of the light beam, whereby said one or more vibration movement means may influence the relative movement between the frame and the mounting means and/or relative movement between the laser light source and the frame.

3. The device for deterring animals according to claim 1, wherein said laser light source is suitable for generating a light beam with a wavelength between 500 nm and 600 nm.

4. The device for deterring animals according to claim 1, wherein the frame movement means comprises one or more wind catching elements for generating the movement by means of wind.

5. The device for deterring animals according to claim 1, the frame movement means comprising a mechanical movement means for generating the movement of the frame with respect to the mounting means.

6. The device for deterring animals according to claim 1, the device further comprising a laser movement means arranged to allow relative movement of the laser light source with respect to the frame.

7. The device for deterring animals according to claim 1, the frame comprising a reflective surface suitable for deflecting the light beam of the laser light, away from the frame, whereby the laser light source is configured to irradiate said reflective surface.

8. (canceled)

9. The device for deterring animals according to claim 1, wherein the reflective surface is flexibly mounted on the frame via reflective surface movement means, allowing relative movement between the reflective surface and the laser light source, thereby varying the direction of the deflected light beam.

10. (canceled)

11. The device for deterring animals according to claim 10, wherein the predetermined frequency is at most 120 Hz.

12. The device for deterring animals according to claim 7, wherein the device comprises one or more vibrational movement means, configured to, preferably in a randomized pattern, add an additional movement component to the light beam generated by the laser light source, said additional movement component varying at least in the plane
perpendicular to the direction of the light beam, whereby said one or more vibration movement means may influence the relative movement between the frame and the mounting means and/or the relative movement between the laser light source and the frame and/or the relative movement between the reflective surface and the frame.

13. The device for deterring animals according to claim 1, wherein the movement of the laser light source with respect to the frame is cyclic and has a predetermined frequency.

14. The device for deterring animals according to claim 1, wherein the movement of the frame with respect to the mounting means is cyclic and has a predetermined frequency.

15. (canceled)

16. (canceled)

17. The device for deterring animals according to claim 1, wherein the device comprises a rangefinder for measuring the free path length of the light beam, and whereby the movement speed of the laser light source and/or the deflection surface is adjusted based on the free path length.

18. The device for deterring animals according to claim 1, wherein the movement of the laser light source and/or of the reflective surface defines a trajectory for the light beam on a plane perpendicular to the average direction of the laser light beam, whereby said trajectory has a first and a second portion forming an essentially closed loop together, whereby the first portion has a total path length equal or longer than the path length of the second portion, whereby the light beam traverses the trajectory over a certain length of time, and whereby the time for traversing the first portion is lower than the time for traversing the second portion, preferably with a factor of at least 10, more preferably at least 50.

19. (canceled)

20. (canceled)

21. The device for deterring animals according to claim 20, wherein said control circuitry is adapted for effecting a cyclical movement on the laser light source and/or on the reflective surface.

22. (canceled)

23. The device for deterring animals according to claim 1, comprising a detection element for detecting persons and/or animals in the area of the device in an area close to the device, wherein the detection element is configured for, at least temporarily, switching off the laser light source upon detection of a person and/or animal.

24. The device for deterring animals according to claim 1, wherein the laser light source is movably and flexibly connected to the frame via the laser movement means, preferably one or more springs.

25. The device for deterring animals according to claim 1, wherein the relative movement of the reflective surface is effected via a an eccentric mechanism cyclically tilting the reflective surface, preferably said eccentric mechanism having a perimeter which over at least 90% of the perimeter monotonously increases in radius from a minimal value, preferably at least 95%, wherein the radius is abruptly returned to its minimal value in the remaining part of the perimeter.

26. The device for deterring animals according to claim 1, wherein the frame movement means comprises the flexible connection element, and comprises at least one or more springs for allowing the relative movement between the frame and the mounting means.

27. The device for deterring animals according to claim 1, wherein the frame comprises an opening or window, through which the light beam is directed, dimensioned to allow at least an angular variation of the light beam of 50° in all dimensions of the opening or window.

28. (canceled)

29. (canceled)
